(19) United States
(12) Patent Application Publication
(10) Pub. No.: US 2015/0122516 A1
(43) Pub. Date: May 7, 2015

(54) Camouflage Yard Tools

(71) Applicant: Jeff Prescott, Franklin, TN (US)

(72) Inventor: Jeff Prescott, Franklin, TN (US)

(21) Appl. No.: 14/073,913

(22) Filed: Nov. 7, 2013

(51) Int. Cl. A01B 1/00; A01D 7/00

(52) U.S. Cl. CPC A01B 1/00; A01D 7/00
USPC 172/371

(57) ABSTRACT

The invention is yard tools. These tools, such as a rake, shovel or hoe are designed to fit in and be concealed by its surroundings and environment. The yard tool could be painted to match the environment or have appendages such as leafs and branches will would always the yard tool to be accessible but hidden in plain sight.

### BACKGROUND OF INVENTION

1. Field of the Invention

The present invention is directed to a providing yard tools more particular ones that are designed to blend into its surroundings.

2. Background

Gardening tools such as rakes, spades, cultivators, shovels and hoes and others have been used and been in existence for 1,000s of years and have been used by human to assist them in their gardening needs.

There is a limited number of good ways currently to store yard tools where they are out of the way but still accessible.

There is still room for improvement in the art.

### SUMMARY OF THE INVENTION

The invention is a yard tool such as a rake, shovel or hoe that will be designed to fit in and be concealed by it surroundings and environment. The yard tool could be painted to match the environment or have appendages such as leafs and branches will would always the yard tool to be accessible but hidden in plain sight.

Further features and advantages of the invention will become apparent from the following detailed description made with reference to the accompanying drawings.

### BRIEF DESCRIPTION OF THE DRAWINGS

Without restricting the full scope of this invention, the preferred form of this invention is illustrated in the following drawings:

FIG. 1 displays some garden tools that are popular;

FIG. 2 displays the garden tools camouflaged with fake leaves;

FIG. 3 shows a garden tool camouflage with a brick pattern; and

FIG. 4 is a garden tool camouflaged in a field or yard.

### BRIEF DESCRIPTION OF THE PREFERRED EMBODIMENTS

There are a number of significant design features and improvements incorporated within the invention.

The invention is a yard tool such as a rake, shovel, shades or hoe that will be designed to fit in and be concealed by it surroundings and environment.

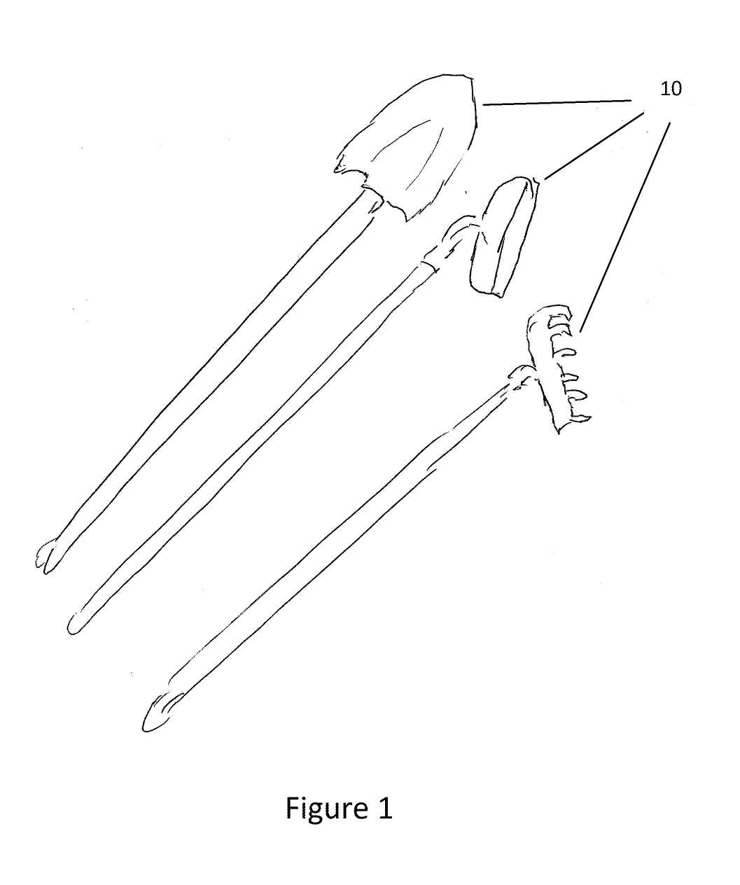

Yard tools 10 as shown in FIG. 1 have been around for thousands of years. There has always been issues on how and where to store them and make them visually appealing. The invention can be used with any number of gardening tools and other tools that have the same needed.

The current invention will address this need as the yard tools 10. The yard tool could be painted to match the environment or have appendages such as leafs and branches will would always the yard tool to be accessible but hidden in plain sight.

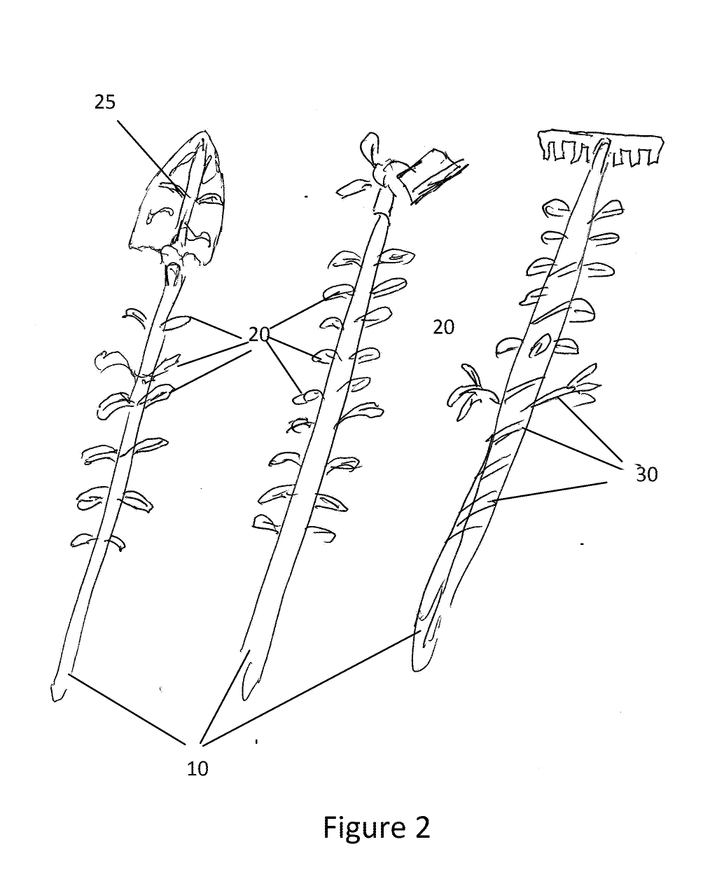

As shown in FIG. 2, the garden tools 10 are camouflaged with colors and texture or in this case with imitation leaves 20 to much the desired environment. The garden tools 10 can also have imitation branches 30 connected to it and/or around it to much the environment.

The coloring of the garden tools 10 in the current invention would match environment and surroundings that the garden tools 10 would be in and stored in. The texture of the garden tools 10 could also match. The texture could be rough and sandy if the garden tools are to be used in the sandy or desert type environment with one or more colors in browns to match. The coloring could be broken up to assist in the camouflaging similar to military clothing. For example the shovel has painted leaves 25 on its head as well as imitation leaves 20 as shown in FIG. 2.

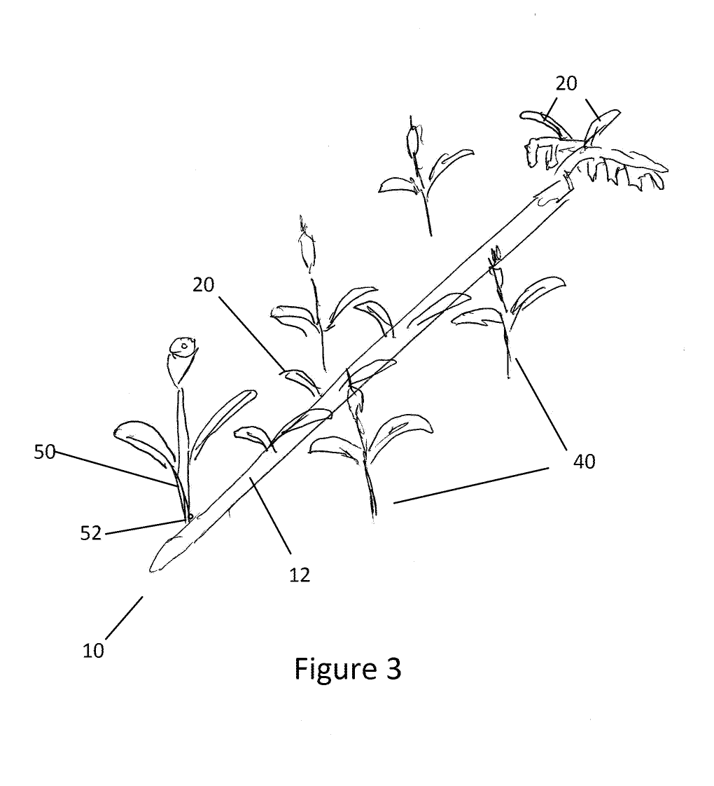

FIG. 3 displays a camouflaged garden tool in a group of plants and flowers 40. The garden tool 10 has a extended imitation flower 50 that extends from the handle 12 of the garden tool 10 as well as have leaves 20. The imitation flower 50 could have a hinge 52 on which it will rotate so that it can lie flat against the handle 12. This can also be used with imitation stalks, branches and other similar items.

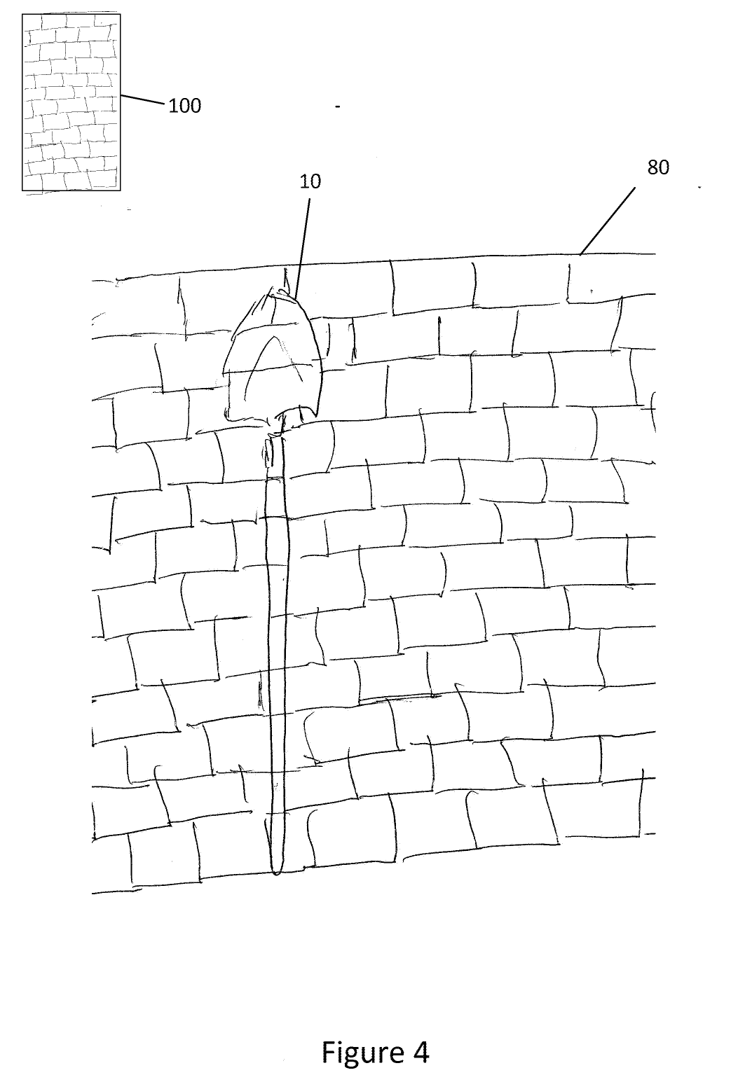

FIG. 4 shows the current invention designed to match a brick background 80, The garden tool 10 has coloring and texture that matches the brick background. This will service to have the garden tool 10 match its background. This can also be done based on a picture 100 of the background that a user would want the garden tool 10 to match.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device comprising: a garden tool that is camouflaged.

2. The device system of claim 1 further comprising:
Where said garden tool is camouflaged is match a particular environment.

3. The device system of claim 1 further comprising:
Where said garden tool is camouflaged with coloring.

4. The device system of claim 1 further comprising:
Where said garden tool is camouflaged with texture.

5. The device system of claim 1 further comprising:
Where said garden tool is camouflaged with imitation leaves.

6. The device system of claim 1 further comprising:
Where said garden tool is camouflaged with imitation branches.

7. The device system of claim 1 further comprising:
Where said garden tool has leaves printed on it.

8. The device system of claim 1 further comprising:
Where said garden tool has imitation flowers on it.

9. The device system of claim 1 further comprising:
Where said garden tool has imitation flowers on it.

10. The device system of claim 1 further comprising:
Where said garden tool is design to match a specific background based on an image.

11. A process comprising: having a garden tool that is camouflaged.

12. The process system of claim 11 further comprising:
having said garden tool is camouflaged match a particular environment.

13. The process system of claim 11 further comprising:
camouflaging said garden tool with coloring.

14. The process system of claim 11 further comprising:
camouflaging said garden tool with with texture.

15. The process system of claim 11 further comprising:
camouflaging said garden tool with with imitation leaves.

16. The process system of claim 11 further comprising:
camouflaging said garden tool with with imitation branches.

17. The process system of claim 11 further comprising:
having leaves printed on said garden tool.

18. The process system of claim 11 further comprising:
having imitation flowers on said garden tool.

19. The process system of claim 11 further comprising:
having imitation flowers on said garden tool.

20. The process system of claim 11 further comprising:
Designing said garden tool to match a specific background based on an image.
